(19) United States
(12) Patent Application Publication
(10) Pub. No.: US 2015/0349645 A1
(43) Pub. Date: Dec. 3, 2015

(54) POWER CONVERTER CONTROLLING METHOD

(71) Applicant: DELTA ELECTRONICS (SHANGHAI) CO., LTD., Shanghai (CN)

(72) Inventors: Dong WEI, Shanghai (CN); De-Zhi JIAO, Shanghai (CN); Dao-Fei XU, Shanghai (CN)

(21) Appl. No.: 14/717,381

(22) Filed: May 20, 2015

(30) Foreign Application Priority Data
May 27, 2014 (CN) 201410228971.1

(51) Int. Cl. H02M 3/24

(52) U.S. Cl. CPC H02M 3/24

(57) ABSTRACT

A power converter controlling method suitable for a power converter is disclosed. The power converter is configured to output a power to a load. The power converter includes a switch. The power converter controlling method includes the following steps. The power outputted from the power converter to the load is detected and a switching frequency of the switch is adjusted according to the power. When the power is greater than a load threshold, the power converter is set to a first working mode, and the switching frequency of the switch is adjusted according to the power in the first working mode. On the other hand, when the power is smaller than or equal to the load threshold, the power converter is set to a burst mode, and the switching frequency is fixed at a setting frequency value in the burst mode.

### RELATED APPLICATIONS

This application claims the priority benefit of China Application Serial Number 201410228971.1, filed May 27, 2014, which is herein incorporated by reference.

### BACKGROUND

1. Field of Invention

The present invention relates to a power converter. More particularly, the present invention relates to a method for controlling a power converter.

2. Description of Related Art

The power converter generally consists of a switch unit, an inductor, a capacitor circuit, and a controlling circuit. The controlling circuit generates a series of control signals to turn on or to turn off the switch unit so that the switch unit outputs a pulse current. The inductor and the capacitor circuit act as a low pass filter, which is utilized to convert the pulse current into a direct current. The direct current is provided to a load.

Generally, there are two common approaches for the controlling circuit. The one adopts a fixed switching frequency and changing a pulse width that is also referred to as pulse width modulation (PWM) control. The other adopts a fixed pulse width and changing a switching frequency in response to a change of the load that is also referred to as variable-frequency control.

When the load is light (low power consumption), power efficiency of the power converter using PWM control is very low. There are two kinds of power loss in the power converter using PWM control. One of them is a conducting loss mainly determined by a magnitude of a load current, and the other is a switching loss proportional to switching times. That is, the switching loss is lowered as the switching times are reduced. As described above, the conducting loss is low when the load is light. However, the switching frequency of the power converter using PWM control in a condition of the light load is exactly equal to that in a condition of a heavy load, and therefore the switching loss is higher. That is the disadvantage of power converter using PWM control.

In contrast, the variable-frequency control can change the switching frequency of the switching unit in response to different power requirements of a load. In order to improve the efficiency of power converter in a condition of light load. a switching frequency of the power converter is decreased along with a decrease of an output power. However, when the output power drops to a specific value (light load or no load), the switching frequency may drop into an audio frequency range sensible by human ears. At this time, a switching operation of the switching unit will generate an audio noise, and a user may hear an annoying high frequency noise continuously.

### SUMMARY

Therefore, the present disclosure provides a power converter controlling method suitable for a power converter. The power converter is configured to output a power to a load and includes a switch. The method includes following steps. The power outputted from the power converter to the load is detected, a switching frequency of the switch is adjusted according to the power. When the power is greater than a load threshold, the power converter is set to a first working mode and the switching frequency of the switch is adjusted according to the power in the first working mode. On the other hand, when the power is smaller than or equal to the load threshold, the power converter is set to a burst mode, and the switching frequency of the switch is fixed at a setting frequency value in the burst mode.

### BRIEF DESCRIPTION OF THE DRAWINGS

The disclosure can be more fully understood by reading the following detailed description of the embodiment, with reference made to the accompanying drawings as follows:

FIG. 1 is a flow chart of a power converter controlling method in an embodiment of the disclosure;

FIG. 2A is a schematic diagram illustrating a power converter used by the power converter controlling method according to an embodiment of the disclosure;

FIG. 2B to FIG. 2G are schematic diagrams illustrating the power converter adopting different types of circuit structures in different embodiments;

FIG. 3 is a relation diagram illustrating a switching frequency adopted by a switch with different powers in the power converter of the power converter controlling method according to an embodiment of the disclosure;

FIG. 4 is a schematic diagram illustrating signal waveforms of switch controlling signals generated by the controlling circuit with different switching frequencies when the power converter is in the first working mode;

FIG. 5 is a schematic diagram illustrating signal waveforms of the switch controlling signals generated by the controlling circuit with the same switching frequency when the power converter is in the burst mode;

FIG. 6 is a diagram illustrating an ideal relation between the power and ratios of a switched-on interval and a switched-off interval occupying in a burst period, in which the switched-on interval and the switched-off interval belong to the switch controlling signal generated by the controlling circuit when the power converter is in the burst mode;

FIG. 7 is a flow chart of the power converter controlling method in an embodiment of the disclosure; and

FIG. 8 is a schematic diagram illustrating signal waveforms of the switch controlling signals generated by the controlling circuit with the same switching frequency when the power converter is in the burst mode in the power converter controlling method of FIG. 7.

### DETAILED DESCRIPTION

Specific embodiments of the present disclosure are further described in detail below with reference to the accompanying drawings, however, the embodiments described are not intended to limit the present disclosure and it is not intended for the description of operation to limit the order of implementation. Moreover, any device with equivalent functions that is produced from a structure formed by a recombination of elements shall fall within the scope of the present disclosure. Additionally, the drawings are only illustrative and are not drawn to actual size.

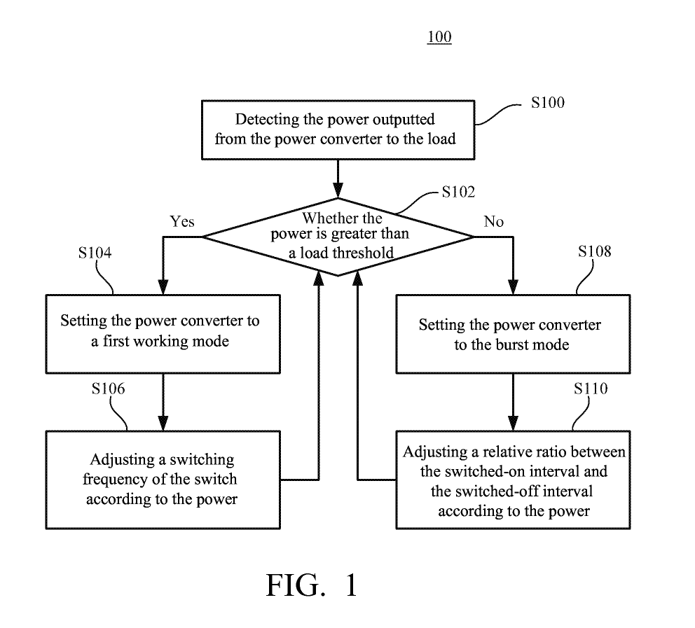

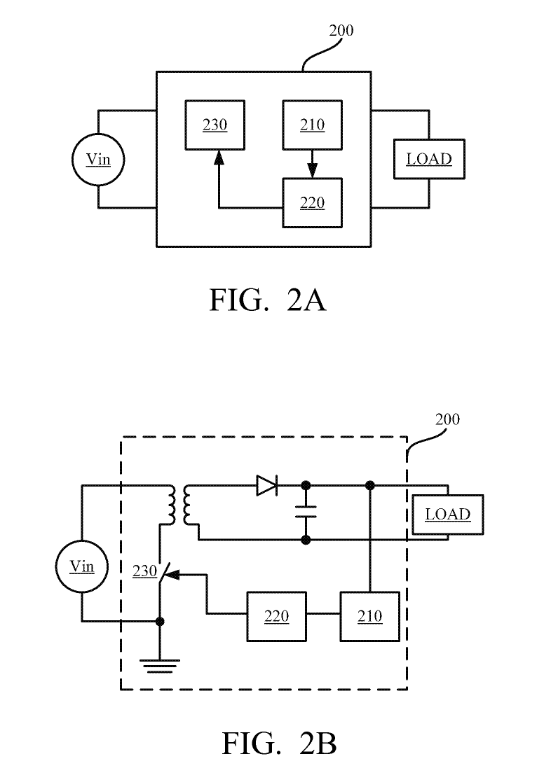

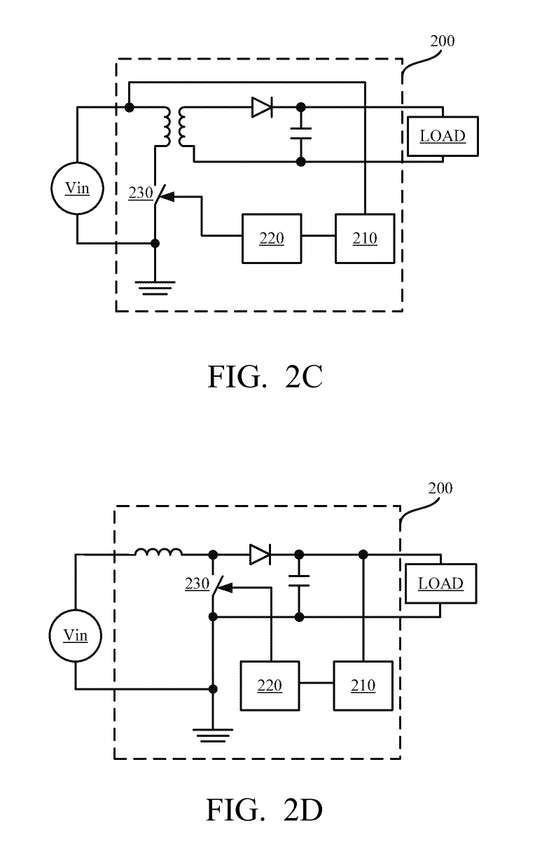

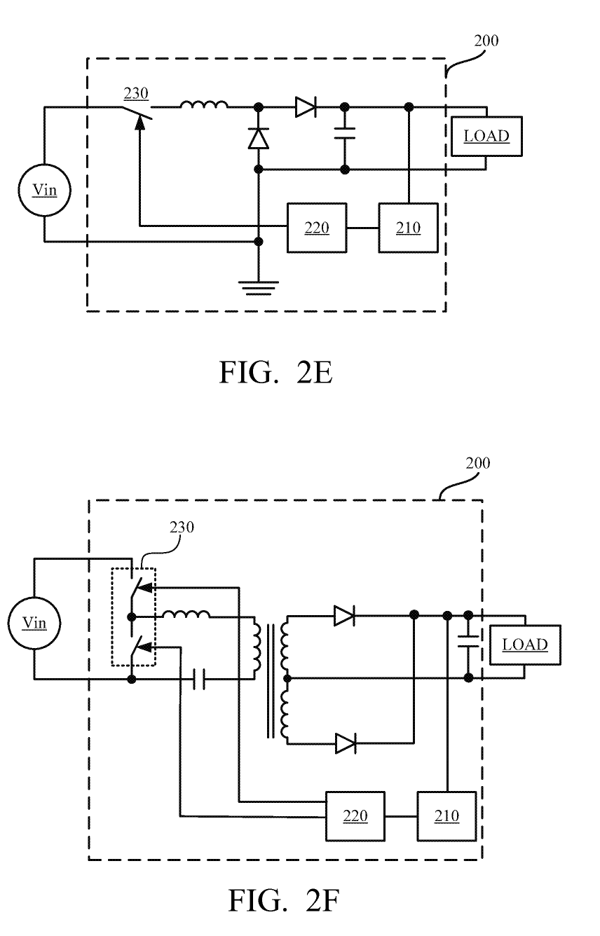

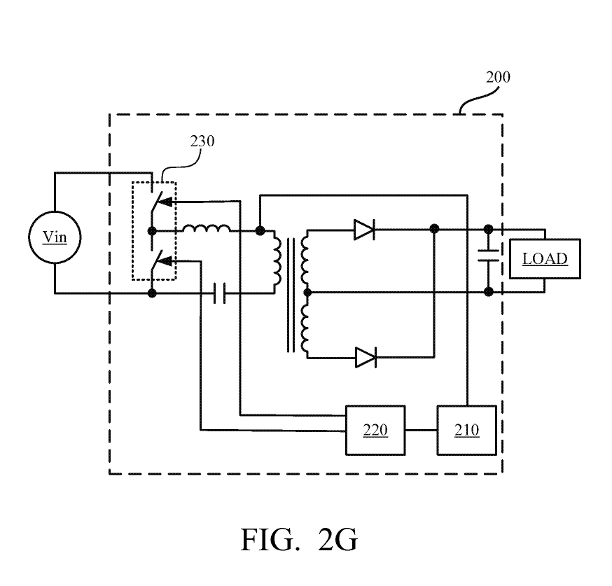

Referring to FIG. 1 and FIG. 2A, FIG. 1 is a flow chart of a power converter controlling method 100 in an embodiment of the disclosure. In the present embodiment, a power converter controlling method 100 is used in a power converter. The power converter may be applied in a switching mode power supply. FIG. 2A is a schematic diagram illustrating a power converter 200 used by the power converter controlling method 100 according to an embodiment of the disclosure.

As shown in FIG. 2A, the power converter 200 is coupled between a power input terminal Vin and a load LOAD. The power converter 200 is configured to convert a power provided by the power input terminal Vin into a power complying with a standard (e.g. a specific voltage, a specific current, a specific frequency or specific power) required by the load LOAD.

The power converter 200 is required to correspondingly provide different power to the load LOAD along with different working states (high speed operation, normal operation, standby or shutdown) of the load LOAD in response to a requirement of the load LOAD.

In the present embodiment, as shown in FIG. 2A, the power converter 200 includes a detecting circuit 210, a controlling circuit 220 and a switch 230. The detecting circuit 210 is configured to detect the power outputted from the power converter 200 to the load LOAD. The controlling circuit 220 is configured to generate a corresponding switch controlling signal (i.e. a pulse driving signal) according to the power obtained and sampled by the detecting circuit 210, and transmits it to the switch 230. The switch 230 switches between on/off states according to the switch controlling signal generated by the controlling circuit 220 so as to enable the power converter 200 to generate different power.

In the embodiment, the power converter 200 has any circuit structure of a flyback converter, a buck converter, a boost converter, and a LLC series resonant converter (LLC-SRC).

Please refer to FIG. 2B to FIG. 2G, which are schematic diagrams illustrating the power converter 200 adopting different types of circuit structures in different embodiments

Both of FIG. 2B and FIG. 2C illustrate the power converter 200 adopting the flyback converter. A difference between FIG. 2B and FIG. 2C is that in an example of FIG. 2B, the detecting circuit 210 in the power converter 200 directly monitors the power outputted from the power converter 200 to the load LOAD at an output side (secondary); in contrast, in an example of FIG. 2C, the detecting circuit 210 in the power converter 200 indirectly obtains the power outputted from the power converter 200 to the load LOAD at an input side (primary).

FIG. 2D is a schematic diagram illustrating the power converter 200 adopting the boost converter. FIG. 2E is a schematic diagram illustrating the power converter 200 adopting the buck converter. In embodiments of FIG. 2D and FIG. 2E, the detecting circuit 210 in the power converter 200 directly detects the power outputted from the power converter 200 to the load LOAD at the output side.

Both of FIG. 2F and FIG. 2G are schematic diagrams illustrating the power converter 200 adopting the LLC series resonant converter. A difference between FIG. 2F and FIG. 2G is that in an example of FIG. 2F, the detecting circuit 210 in the power converter 200 directly detects the power outputted from the power converter 200 to the load LOAD at the output side (secondary); in contrast, in an example of FIG. 2G, the detecting circuit 210 in the power converter 200 indirectly obtains the power outputted from the power converter 200 to the load LOAD at the input side (primary).

As shown in FIG. 1, the power converter controlling method 100 performs a step S100 to detect the power outputted from the power converter 200 to the load LOAD. In the embodiment, the power is mainly determined by a requirement of the load LOAD at that time. Corresponding to the load LOAD has different working states (high speed operation, normal operation, standby or shutdown), the load LOAD may be in a heavy load state requiring high power, in a normal load state requiring median power, in a light load state requiring low power, or even in a zero load state requiring no power.

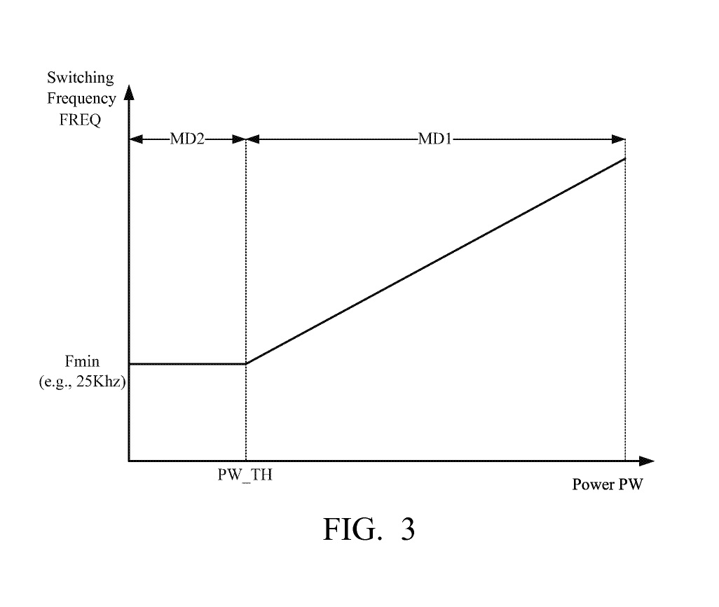

Referring to FIG. 1, FIG. 2A and FIG. 3 together, FIG. 3 is a relation diagram illustrating a switching frequency FREQ adopted by the switch 230 with different power in the power converter 200 of the power converter controlling method 100 according to an embodiment of the disclosure.

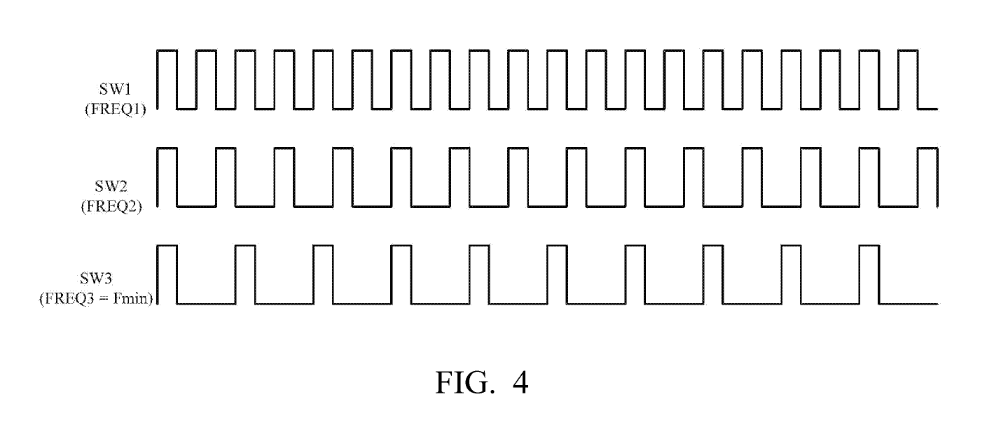

The power converter controlling method 100 performs a step S102 to determine whether the power outputted from the power converter 200 to the load LOAD is greater than a load threshold PW_TH. When the power PW is greater than the load threshold PW_TH, a step S104 is performed to set the power converter 200 to a first working mode MD1, and a step S106 is performed to adjust a switching frequency FREQ of the switch 230 according to the power PW. In the embodiment, the first working mode MD1 is a variable-frequency working mode. In the variable-frequency working mode, the step S106 is to adjust the switching frequency FREQ of the switch 230 according to the power PW so as to correspond the switching frequency FREQ to the power PW. For example, in the first working mode MD1 (i.e. variable-frequency working mode in the embodiment) in FIG. 3, the switching frequency FREQ is substantially proportional to the power PW. Please refer to FIG. 4 together, which is a schematic diagram illustrating signal waveforms of switch controlling signals SW1˜SW3 generated by the controlling circuit 220 with different switching frequencies FREQ1˜FREQ3 when the power converter 200 is in the first working mode MD1 (i.e. variable-frequency working mode in this embodiment). In another embodiment, the first working mode MD1 may also be a fixed-frequency mode or a working mode with a combination of fixed frequency and variable frequencies.

As shown in FIG. 4, switch controlling signals SW1˜SW3 include periodic pulses, and intervals of the periodic pulses are determined by the switching frequencies FREQ1˜FREQ3. An interval between two periodic pulses in the switch controlling signal SW1 is shorter, and an interval between two periodic pulses in the switch controlling signal SW3 is longer.

In the first working mode MD1 (i.e. variable-frequency working mode in the embodiment), when the power PW is higher(heavy load), the switching frequency FREQ of the switch 230 is higher such as the switch controlling signal SW1 with the switching frequency FREQ1 in FIG. 4. On the other hand, when the power PW is lower, the switching frequency FREQ of the switch 230 is lower such as the switch controlling signal SW3 with the switching frequency FREQ3 in FIG. 4. That is, the power converter 200 can change the switching frequency FREQ of the switch 230 in response to different power requirements of the load LOAD.

In order to improve efficiency when the load is light, the switching frequency FREQ of the switch 230 is decreased along with a decrease of the power PW, as shown in FIG. 3. However, if the power PW drops to a specific value (light load or no load) and the switching frequency correspondingly drops, then the switching frequency may drop into a audio frequency range (20 to 20000 hertz in general) sensible by human ears. At this time, a switching operation of the switch 230 would generate an audio noise, and a user may hear an annoying high frequency noise continuously.

In the disclosure, when the power PW drops to the load threshold PW_TH (at this time, the switching frequency FREQ is correspondingly at the setting frequency value Fmin, as shown in FIG. 3), the power converter controlling method 100 will keep the switching frequency FREQ at the setting frequency value Fmin even if the power PW continues to drop. The setting frequency value Fmin is not decreased, and another approach will be used in response to a change of the power. As a result, the audio noise generated by the switching operation of the switch 230 can be avoided. In one embodiment, the setting frequency value Fmin can be set higher than a maximum audio frequency sensible by human ears. For example, the setting frequency value Fmin can be set at 25 kHz. In one embodiment, the load threshold PW_TH is the power PW generated by the power converter 200 when the switching frequency FREQ is equal to the setting frequency value Fmin.

That is, in the first working mode MD1 (i.e. variable-frequency working mode in the embodiment), the switching frequency FREQ is higher than the setting frequency value Fmin to avoid the generation of the audio noise.

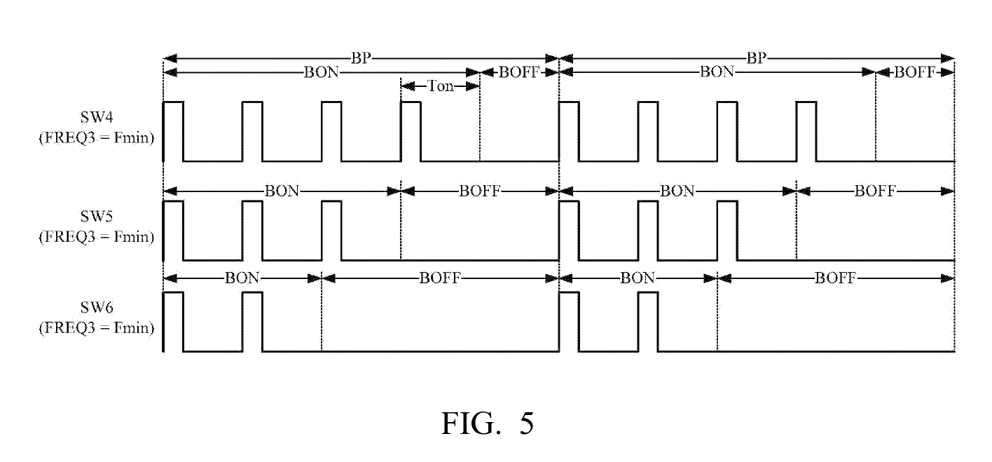

Referring to FIG. 1, FIG. 3 and FIG. 5 together, FIG. 5 is a schematic diagram illustrating signal waveforms of the switch controlling signals SW4˜SW6 generated by the controlling circuit 220 with the same switching frequency FREQ3 when the power converter 200 is in a burst mode MD2.

When the power PW is smaller than or equal to the load threshold PW_TH, the power converter controlling method 100 performs a S108 to set the power converter 200 to the burst mode MD2. In the burst mode MD2, the power converter controlling method 100 fixes the switching frequency FREQ at the setting frequency value Fmin, and does not decrease the switching frequency FREQ anymore. In the embodiment shown in FIG. 5, it is assumed that the switching frequency FREQ3 is equal to the setting frequency value Fmin (e.g. 25 k hertz).

The switch 230 switches according to the switch controlling signals. As show in FIG. 5, the switch controlling signals SW4˜SW6 include periodic pulses, and intervals of the periodic pulses are decided by the switching frequency FREQ3. In the burst mode MD2 in the FIG. 5, all of frequencies of the switch controlling signals SW4˜SW6 are equal to the switching frequency FREQ3.

As shown in FIG. 5, in the burst mode MD2, each of the switch controlling signals SW4˜SW6 has a burst periods BP including a switched-on interval BON and a switched-off interval BOFF. The periodic pulses are provided to the switch 230 according to the switching frequency FREQ3 during the switched-on interval BON, and providing the periodic pulses to the switch 230 is stopped during the switched-off interval BOFF.

In the burst mode MD2, a step S110 is performed to adjust a relative ratio between the switched-on interval BON and the switched-off interval BOFF according to the power PW. If the power PW is increased, then a proportion of the switched-on interval BON is increased (e.g. in FIG. 5, the proportion of the switched-on interval BON of the pulse driving signal SW4 is 80%; and the proportion of the switched-off interval BOFF is 20%). If the power PW is decreased, then the proportion of the switched-off interval BOFF is increased (e.g. in FIG. 5, the proportion of the witched-on interval BON of the pulse driving signal SW6 is 40%; and the proportion of the switched-off interval BOFF is 60%).

For the convenience of description, only exemplary waveforms are illustrated in the figures. Each burst period BP includes several pulses (switch controlling signals SW4˜SW6 have respectively two to four pulses), therefore a minimum adjustment unit between the switched-on interval BON and the switched-off interval BOFF is 20%, but the disclosure is not limited thereto. When applying to a high frequency signal in practice, each burst period BP may includes dozens, hundreds, or thousands of pulses, and an adjustment precision between the switched-on interval BON and the switched-off interval BOFF may be higher than 20% (e.g. 1% or higher than 1%).

In the embodiment, the switched-off interval BOFF is longer than or equal to a switching period Ton of the switched-on interval BON. The switching period Ton is a working period of the periodic pulses in the switched-on interval BON. In other words, the switching period Ton is corresponding to the switching frequency in the switched-on interval BON. A width occupied by the switched-off interval BOFF is at least greater than or equal to a switching period Ton corresponding to the switching frequency FREQ3. That is, the switched-off interval BOFF is longer than or equal to a transition period corresponding to the switching frequency FREQ3.

In addition, a burst frequency corresponding to the burst period BP (a sum of the switched-on interval BON and the switched-off interval BOFF) should be lower than a mechanical oscillation frequency of a passive component which is a resistor, a capacitor, an inductor, a diode, or the like.

That is to say, when the power PW is lower than or equal to the load threshold PW_TH, the power converter controlling method 100 enters the burst mode MD2 to fix the switching frequency FREQ at the setting frequency value Fmin, and does not decrease the switching frequency FREQ anymore, in which the relative ratio between the switched-on interval BON and the switched-off interval BOFF is adjusted in response to a change of the power PW.

It should be described in particular that the adjustment of the switch controlling signals is not limited to the examples illustrated in FIG. 5. In a practical application, the switch controlling signal is a high frequency signal, and the switched-on interval BON includes dozens to thousands of periodic pulses. Therefore, every ratio adjustment between the switched-on interval BON and the switched-off interval BOFF can reach a very high precision (e.g. 5%), which approximates to a linear adjustment. The disclosure is not limited to the adjustment precision of 20% in FIG. 5.

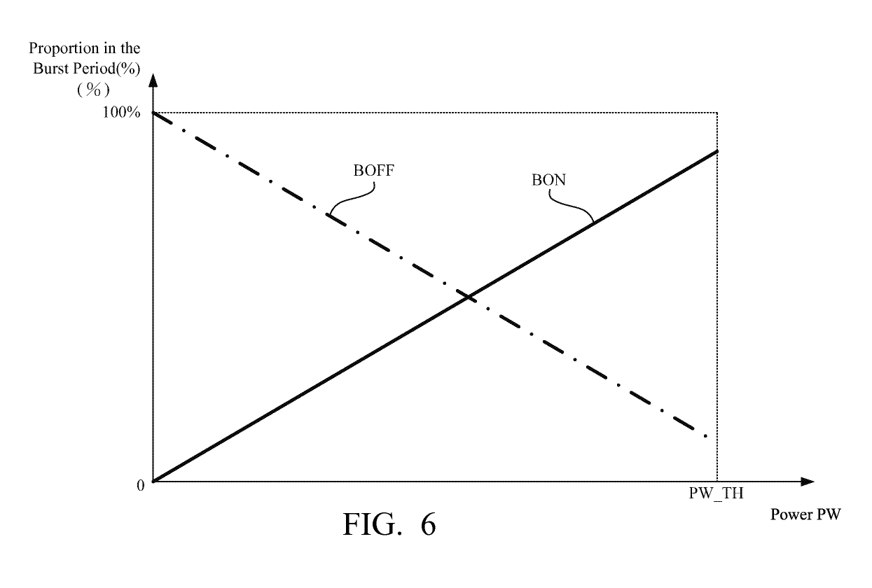

Please refer to FIG. 6 together which is a diagram illustrating an ideal relation between the power PW and a ratio that the switched-on interval BON and the switched-off interval BOFF occupy in a burst period BP, in which the switched-on interval BON and the switched-off interval BOFF belong to the switch controlling signal generated by the controlling circuit 220 when the power converter 200 is in the burst mode MD2 (the switching frequency FREQ is fixed at the setting frequency value Fmin). In the burst mode MD2, when the power PW is increased, the switched-on interval BON is increased, and the switched-off interval BOFF is decreased at the same time.

Moreover, the power converter controlling method 100 in the embodiment of FIG. 1 switches between the first working mode MD1 (i.e. variable-frequency working mode in the embodiment) and the burst mode MD2 based on whether the power PW is greater than the load threshold PW_TH. However, if the power PW required by the load is floating around the load threshold PW_TH (e.g. frequently switching in a range of 5% of the threshold PW_TH), then the controlling circuit 220 is required to change the way controlling the switch 230 frequently so that extra power consumptions for computing may be generated and it may be instable in operation. Therefore, another embodiment of the disclosure provides a power converter controlling method 300 having steps related to a hysteresis control.

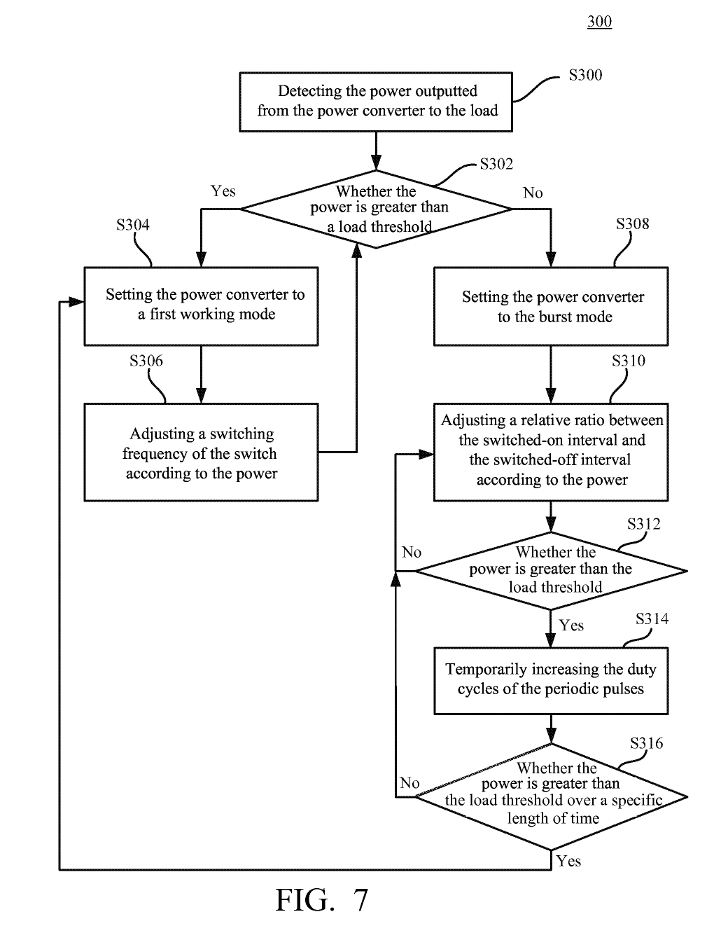

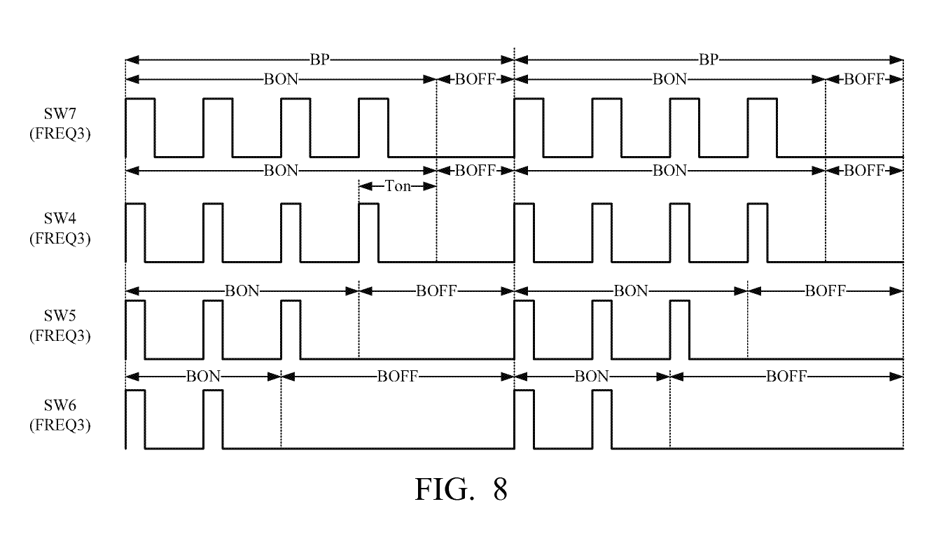

Referring to FIG. 7 together, FIG. 7 is a diagram illustrating a flowchart of the power converter controlling method 300 according to an embodiment of the disclosure. Details of steps S300-S310 are substantially the same with the steps S100-S110 of the power converter controlling method 100, and they will not be repeated.

Then, referring to FIG. 2A, FIG. 3, FIG. 7 and FIG. 8 together, FIG. 8 is a schematic diagram illustrating signal waveforms of the switch controlling signals SW4˜SW7 generated by the controlling circuit 220 with the same switching frequency FREQ3 when the power converter 200 is in the burst mode MD2 in the power converter controlling method 300 of FIG. 7.

In a step S310 in FIG. 7, when the power converter 200 is in the burst mode MD2, a relative ratio between the switched-on interval BON and the switched-off interval BOFF is adjusted according the power PW such as the switch controlling signals SW4˜SW6 shown in FIG. 8. Please refer to the description in the previous embodiments.

Then, a step S312 is performed to detect whether the power PW is greater than the load threshold PW_TH. When it is detected the power PW changes from smaller than the load threshold PW_TH to greater than the load threshold PW_TH in a step S312, the power converter controlling method 300 performs a step S314 to temporarily keep the power converter 200 in the burst mode MD2, and to keep the switching frequency FREQ at the setting frequency value Fmin (i.e. the switching frequency FREQ3 in the embodiment), and the power converter controlling method 300 temporarily increases the duty cycles of the periodic pulses in the switch controlling signals such as the switch controlling signal SW7 shown in FIG. 8 in response to a change of the power PW.

In the embodiment, the switched-off interval BOFF is longer than or equal to the switching period Ton of the switched-on interval BON. The switching period Ton is a working period of the periodic pulse in the switched-on interval BON. That is, the switching period Ton is corresponding to the switching frequency in the switched-on interval BON. A width occupied by the switched-off interval BOFF is at least longer than or equal to a switching period Ton corresponding to the switching frequency FREQ3. In other words, the switched-off interval BOFF is longer than or equal to the switching period corresponding to the switching frequency FREQ3.

Furthermore, a burst frequency corresponding to the burst period BP (a sum of the switched-on interval BON and the switched-off interval BOFF) should be lower than a mechanical oscillation frequency of a passive component which is a resistor, a capacitor, an inductor, a diode, or the like.

As shown in FIG. 8, when the power PW is greater than or equal to the load threshold PW_TH, a step S314 is performed to temporarily extend the time of the periodic pulse of the switch controlling signal SW7 being at a high level in a situation that the power converter controlling method 300 keeps the switching frequency FREQ3 at the setting frequency value Fmin. In other words, a duty cycle of the periodic pulse is temporarily increased in response to the change of the power PW.

Then, a step S316 is performed to determine whether the power PW is greater than the load threshold PW_TH for a specific period of time. If it is not over the specific period of time, the power converter controlling method returns to the step S310 and continue to set the power converter 200 to the burst mode MD2. Accordingly, frequently switching the working mode of the power converter 200 is avoided, and it is still corresponding to the change of the power PW.

If the power PW is greater than the load threshold PW_TH for the specific period of time, in a step S304, the power converter 200 is set to the first working mode MD1 (i.e. variable-frequency working mode in the embodiment) so as to correspond to the change of the power PW better.

In addition, a determination standard in the step S316 is not limited to the approach described above (determining whether the power PW is greater than the load threshold PW_TH over the specific period of time). In another embodiment, the step S316 may also use whether the power PW is obviously greater than the load threshold PW_TH (e.g. greater than the load threshold PW_TH for 20%) as the determination standard.

If the power PW is obviously greater than the load threshold PW_TH, the step S304 is performed; and if the power PW is not obviously greater than the load threshold PW_TH, the power converter controlling method returns to the step S310.

Although the present disclosure has been described in considerable detail with reference to certain embodiments thereof, other embodiments are possible. Therefore, the spirit and scope of the appended claims should not be limited to the description of the embodiments contained herein.

What is claimed is:

1. A power converter controlling method, suitable for a power converter configured to output a power to a load and the power converter comprising a switch, the power converter controlling method comprising:
detecting the power outputted from the power converter to the load, and adjusting a switching frequency of the switch according to the power;
when the power is greater than a load threshold, setting the power converter to a first working mode, and adjusting the switching frequency of the switch according to the power in the first working mode; and
when the power is smaller than or equal to the load threshold, setting the power converter to a burst mode, and fixing the switching frequency of the switch at a setting frequency value in the burst mode.

2. The power converter controlling method of claim 1, wherein the switch switches according to a switch controlling signal comprising a plurality of periodic pulses, and an interval of the periodic pulses is decided by the switching frequency.

3. The power converter controlling method of claim 2, wherein the burst mode has a burst period comprising a switched-on interval and a switched-off interval, and the power converter controlling method comprises:
providing the periodic pulses to the switch according to the switching frequency during the switched-on interval; and
stopping providing the periodic pulses to the switch during the switched-off interval.

4. The power converter controlling method of claim 3, comprising:
adjusting a relative ratio between the switched-on interval and the switched-off interval according to the power in the burst mode;
increasing a proportion of the switched-on interval if the power is increased; and
increasing a proportion of the switched-off interval if the power is decreased.

5. The power converter controlling method of claim 3, wherein the switched-off interval is longer than or equal to a switching period corresponding to the switching frequency.

6. The power converter controlling method of claim 3, wherein a burst frequency corresponding to the burst period is lower than a mechanical oscillation frequency of a passive component.

7. The power converter controlling method of claim 2, wherein the periodic pulses have a plurality of duty cycles respectively, and when it is detected that the power changes from smaller than the load threshold to greater than the load threshold, the power converter controlling method comprises:
temporarily keeping the power converter in the burst mode, keeping the switching frequency at the setting frequency value, and temporarily increasing the duty cycles of the periodic pulses in response to a change of the power.

8. The power converter controlling method of claim 7, wherein when the power converter is temporarily kept in the burst mode, the power converter controlling method comprises:
setting the power converter to the first working mode in response to the change of the power if the power is greater than the load threshold for a specific period of time.

9. The power converter controlling method of claim 7, wherein when the power converter is temporarily kept in the burst mode, the power converter controlling method comprises:
setting the power converter to the first working mode in response to the change of the power if the power is obviously greater than the load threshold.

10. The power converter controlling method of claim 1, wherein the setting frequency value corresponding to the load threshold is higher than a maximum audio frequency sensible by a human ear.

11. The power converter controlling method of claim 1, wherein the setting frequency value is substantially equal to 25000 hertz.

12. The power converter controlling method of claim 1, wherein the power converter is a flyback converter, a buck converter, a boost converter, or a LLC series resonant converter (LLC-SRC).

13. The power converter controlling method of claim 1, wherein the first working mode is a variable-frequency working mode, and the power converter controlling method comprises:
adjusting the switching frequency of the switch according to the power in the variable-frequency working mode to correspond the switching frequency to the power, wherein the switching frequency is higher than or equal to the setting frequency value.

14. The power converter controlling method of claim 1, wherein the first working mode is a fixed-frequency mode or a working mode with a combination of fixed-frequency and variable frequencies.
